(19) United States
(12) Patent Application Publication
(10) Pub. No.: US 2021/0226668 A1
(43) Pub. Date: Jul. 22, 2021

(54) ANTENNA ACTIVATION METHOD FOR A NEAR-FIELD COMMUNICATION DEVICE

(71) Applicant: STMicroelectronics (Rousset) SAS, Rousset (FR)

(72) Inventors: Nicolas CORDIER, Aix-en-Provence (FR); Pierre RIZZO, Trets (FR); Alexandre TRAMONI, Le Beausset (FR)

(73) Assignee: STMicroelectronics (Rousset) SAS, Rousset (FR)

(21) Appl. No.: 17/147,919

(22) Filed: Jan. 13, 2021

(30) Foreign Application Priority Data
Jan. 17, 2020 (FR) 2000427

(51) Int. Cl. H04B 5/00; H01Q 3/24

(52) U.S. Cl. CPC H04B 5/0037; H04B 5/0043; H01Q 3/24; H04B 5/0081; H04B 5/0031

(57) ABSTRACT

A first electronic device includes a first near-field communication antenna and a second near-field communication antenna. The first and second near-field communication antennas of the first electronic device are alternately activated. The first antenna is dedicated to supporting communication between the first electronic device and a second electronic device. The second antenna is dedicated to support charging of the second electronic device.

### PRIORITY CLAIM

This application claims the priority benefit of French Application for Patent No. 2000427, filed on Jan. 17, 2020, the content of which is hereby incorporated by reference in its entirety to the maximum extent allowable by law.

### TECHNICAL FIELD

The present disclosure generally relates to electronic devices and, more specifically, to devices comprising a near-field communication (NFC) circuit, also referred to as an NFC device.

### BACKGROUND

There currently exist many examples of NFC devices, in particular connected objects such as smartwatches and smartbands. Such connected objects are generally capable of exchanging data with one another and with other types of NFC devices, for example, with computers and cell phones also provided with near-field communication circuits.

Most NFC devices comprise an electric power source, typically a battery, the charging of which generally requires using a dedicated accessory, for example, a cable or an inductive charging base. The user is thus often forced to acquire and to carry, in addition to the charging accessories intended for other electronic devices already in his/her possession, a specific charging accessory for each of his/her NFC devices.

There is a need to improve NFC devices and their current charging methods.

There is a need to overcome all or part of the disadvantages of NFC devices and of their known charging methods.

### SUMMARY

An embodiment provides a method where at least one first near-field communication antenna and at least one second near-field communication antenna of a same first electronic device are alternately activated, the second near-field communication antenna being dedicated to the charging of a second electronic device.

According to an embodiment, the first near-field communication antenna is dedicated to data exchanges.

According to an embodiment, the second device comprises a third near-field communication antenna.

According to an embodiment, the first, second, and third near-field communication antennas are configured to operate at a frequency in the order of 13.56 MHz, preferably equal to 13.56 MHz.

According to an embodiment, the second near-field communication antenna is activated according to the state of one or a plurality of sensors of the first device.

According to an embodiment, the sensor(s) are selected among: an accelerometer, preferably a three-axes accelerometer; a gyroscope; a luminosity sensor; and a proximity sensor.

According to an embodiment, the second near-field communication antenna is activated when the first device is connected to an external power supply source.

According to an embodiment, the activation of the second near-field communication antenna is enabled by an actuator capable of receiving an operator's action.

According to an embodiment, the second near-field communication antenna is activated during standby or off periods of a display of the first device.

According to an embodiment, the second near-field communication antenna is activated by a capacitive sensor.

According to an embodiment, the first and second devices are equipped with a magnetic system for aligning the second device with respect to the second near-field communication antenna.

According to an embodiment, the first and second near-field communication antennas are periodically activated.

According to an embodiment, the first device is a mobile terminal, preferably a cell phone or a tablet computer.

According to an embodiment, the second device is a connected object, preferably, a smartwatch or a smartband.

An embodiment provides a device configured to implement the method such as described.

An embodiment provides a cell phone comprising two near-field communication antennas, configured to implement the method such as described.

### BRIEF DESCRIPTION OF THE DRAWINGS

The foregoing and other features and advantages of the present invention will be discussed in detail in the following non-limiting description of specific embodiments and implementation modes in connection with the accompanying drawings, in which:

FIG. 1 very schematically shows in the form of blocks an example of a near-field communication system of the type to which the described embodiments apply as an example;

FIG. 2 very schematically shows in the form of blocks an embodiment of a near-field communication circuit;

FIG. 3 is a timing diagram of an implementation mode of a method of controlling the circuit of FIG. 2;

FIG. 4 very schematically shows in the form of blocks an example of a cell phone comprising a near-field communication circuit of the type of the circuit described in relation with FIG. 2;

FIG. 5 illustrates an example of application to the charging, by a mobile terminal, of a connected object; and

FIG. 6 illustrates an example of application to a data exchange between a mobile terminal and another device.

### DETAILED DESCRIPTION

Like features have been designated by like references in the various figures. In particular, the structural and/or functional elements common to the different embodiments and implementation modes may be designated with the same reference numerals and may have identical structural, dimensional, and material properties.

For clarity, only those steps and elements which are useful to the understanding of the described embodiments and implementation modes have been shown and will be detailed. In particular, the protocols implemented during a near-field communication between two NFC devices are not detailed, the described embodiments and implementation modes being compatible with usual protocols of near-field communication between two NFC devices.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “front”, “rear”, “top”, “bottom”, “left”, “right”, etc., or relative positions, such as terms “above”, “under”, “upper”, “lower”, etc., or to terms qualifying directions, such as terms “horizontal”, “vertical”, etc., it is referred to the orientation of the drawings or to a cell phone in a normal position of use.

In the following description, the term NFC device designates an electronic device integrating at least one near-field communication (NFC) circuit.

Unless specified otherwise, the expressions “around”, “approximately”, “substantially” and “in the order of” signify within 10%, and preferably within 5%.

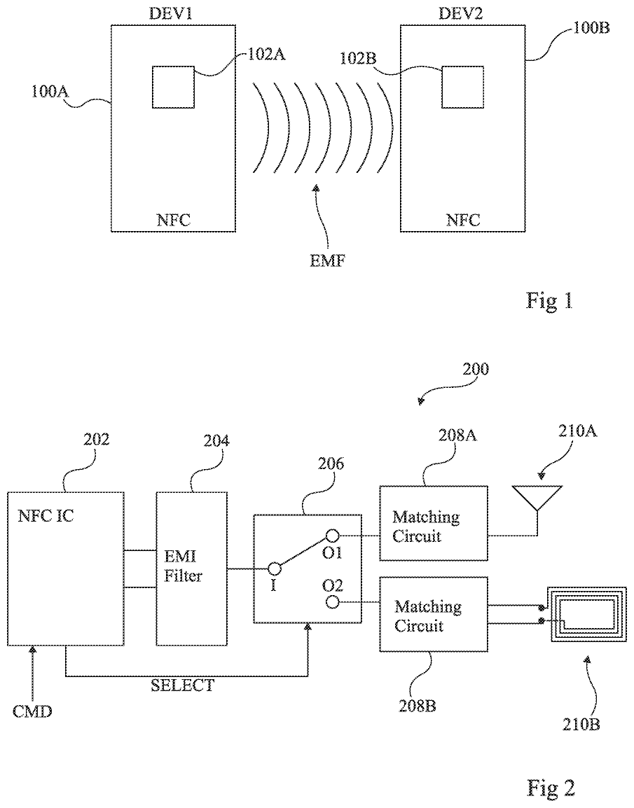

FIG. 1 very schematically shows in the form of blocks an example of a near-field communication system to which the described embodiments apply as an example.

In this example, a NFC device 100A (DEV1) communicates, by near-field electromagnetic coupling, with another NFC device 100B (DEV2). According to applications, for a communication, one of NFC devices 100A, 100B operates in so-called reader mode while the other NFC device 100A, 100B operates in so-called card mode, or the two NFC devices 100A and 100B communicate in peer-to-peer mode (P2P).

Each NFC device 100A, 100B integrates a near-field communication circuit symbolized, in FIG. 1, by a block 102A, 102B. Near-field communication circuits 102A and 102B each comprise various elements or electronic circuits for generating and/or detecting a radio frequency signal by means of an antenna (not shown). During a communication between NFC devices 100A and 100B, the radio frequency signal generated by one of NFC devices 100A, 100B is captured by the other NFC device 100A, 100B located within its range.

It is arbitrarily considered, as illustrated in FIG. 1, that NFC device 100A emits an electromagnetic field (EMF) to initiate a communication with NFC device 100B. The EMF field is captured by NFC device 100B as soon as it is located within its range. A coupling then forms between two oscillating circuits, that of the antenna of NFC device 100A and that of the antenna of NFC device 100B in the present example. Such a coupling causes a variation of the load formed by the circuits of NFC device 100B on the oscillating circuit for generating the EMF field of NFC device 100A.

In practice, for a communication, the corresponding phase or amplitude variation of the emitted field is detected by device 100A, which then starts a protocol of NFC communication with device 100B. On the side of NFC device 100A, it is in practice detected whether the amplitude of the voltage across the oscillating circuit and/or the phase shift with respect to the signal generated by circuit 102A come out of amplitude and phase windows each defined by a lower threshold and an upper threshold.

In the case of a communication, once NFC device 100A has detected the presence of NFC device 100B in its field, it starts a procedure for establishing a communication, implementing transmissions of requests by NFC device 100A and of answers by NFC device 100B (polling sequence such as defined in the NFC Forum specifications). The circuits of NFC device 100B, if they are at stand-by, are then reactivated.

For power saving reasons, emitting device 100A, be it connected to the power distribution mains or directly or indirectly powered with a battery, is generally set to standby when it is not used for a communication. The NFC devices are thus often equipped with circuits of detection of another device located within their range to leave a standby mode for communication purposes.

In certain applications, when a NFC device is not communicating, it is switched to the so-called low power mode, or standby mode, to decrease the consumed power. This is particularly true for NFC devices powered with batteries. In such a low power mode, a NFC device configured in reader mode executes a so-called tag detection or card detection mode and executes detection loops. The detection is similar to that performed when the device is not in low power mode. However, in normal mode, the emission of the carrier is continuous and periodically includes polling phases while, in low power mode, the emission of the field is performed in periodic bursts and with no polling frame in order to decrease the power consumption. The bursts have a duration much shorter (by a ratio of at least ten, preferably of at least one hundred) than the duration of a card polling request in normal mode.

When it is in low power mode, a NFC device capable of operating both in reader mode and in card mode alternates between field emission phases and field detection phases. The field emission phases correspond to the emission of polling frames to detect the presence of a NFC device in card mode within range. The field detection phases enable the NFC device to detect the presence of a field emitted by another NFC device in reader mode.

Applications mainly aim at taking advantage of the EMF field to allow data exchanges between NFC devices 100A and 100B. This typically corresponds to a case where NFC device 100A is a mobile terminal and where NFC device 100B is a card (tag), for example, a transport card.

Other applications rather aim at taking advantage of the EMF field to allow power exchanges between NFC devices 100A and 100B. This typically corresponds to a case where NFC device 100A is a charging base and where NFC device 100B is a connected object. In this case, device 100A generally enables to charge a power source (not shown), for example, a battery, within the NFC device 100B.

Most of the time, the near-field communication circuit 102A of NFC device 100A is associated with an antenna having a different geometry according to whether the near field communication with NFC device 100B is rather used for data exchanges or for power exchanges. In other words, a NFC device 100A equipped with an antenna having its geometry optimized to exchange data with NFC device 100B does not generally enable to efficiently charge NFC device 100B, and vice versa. This accordingly limits the functionalities of device 100A.

FIG. 2 very schematically shows in the form of blocks an embodiment of a near-field communication circuit 200. Circuit 200, for example, forms part of a NFC device similar to the NFC device 100A of FIG. 1.

According to this embodiment, circuit 200 comprises an integrated circuit chip or circuit 202 (NFC IC), for example, a near-field communication controller or NFC controller. Chip 202 includes a radio-frequency (RF) port that is coupled, preferably connected, to an electromagnetic interference filtering component 204 (EMI Filter), more simply called filter 204 in the following description.

Filter 204 is coupled, preferably connected, to an input terminal, noted I, of a switch 206. Switch 206 further has two output terminals, noted O1 and O2. Each output terminal O1, O2 of switch 206 is coupled, preferably connected, to an impedance matching circuit 208A, 208B. Each impedance matching circuit 208A, 208B is coupled, preferably connected, to a near-field communication antenna 210A, 201B, or NFC antenna.

According to a preferred embodiment, one of antenna 210A, 201B (for example, antenna 210A) is optimized to exchange data with other NFC devices while the other antenna 210A, 201B (antenna 210B, still in this example) is dedicated to the charging of other NFC devices. In this case, the antenna 210B dedicated to the charging preferably has a quality factor greater than that of the antenna 210A dedicated to data exchanges. In practice, when each antenna 210A, 210B is formed of an inductive winding, the antenna 210B dedicated to near-field charging, for example, comprises a number of spirals (i.e., windings) greater than that of the antenna 210A dedicated to data exchanges. This advantageously enables antenna 210B to deliver, during the charge of a device, a supply power greater than that which would be provided by antenna 210A.

In the targeted applications, the antennas are preferably formed of one or of a plurality of planar windings supported by a substrate or by a shell of the NFC device.

In the embodiment illustrated in FIG. 2, switch 206 receives a control signal SELECT, or selection signal. Signal SELECT is, for example, a binary signal transmitted by chip 202. In practice, the state of binary signal SELECT is a function of a signal CMD transmitted to chip 202 by an application processor (not shown) external to circuit 200, for example, over a communication link between the application processor and chip 202. According to a preferred embodiment, switch 206 is configured to connect its input I to one or the other of its outputs O1, O2 according to the state of control signal SELECT, that is, according to the signal CMD received by chip 202.

The control signal SELECT of switch 206 thus enables to select the antenna 210A, 201B to be coupled to near-field communication chip 202. In other words, signal SELECT enables to alternately activate one or the other of antennas 210A, 201B for near-field transmission and/or reception. Signal SELECT thus advantageously enables to select and to activate the antenna 210A or 201B which is best adapted according to cases (data exchange or charging) of a desired operating mode.

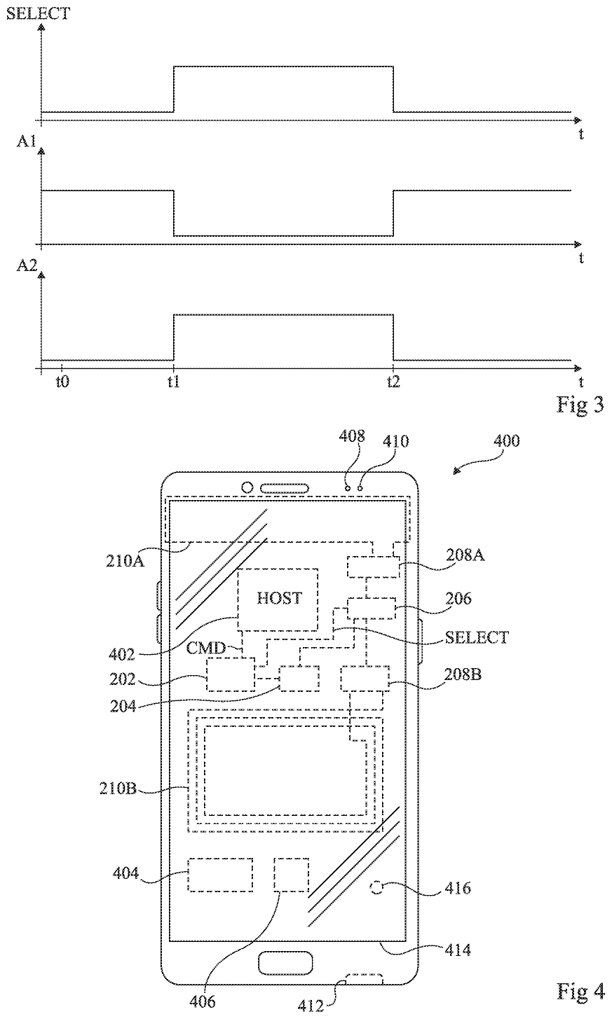

FIG. 3 is a timing diagram of an embodiment of a method for controlling the circuit 200 of FIG. 2. The timing diagram of FIG. 3 more particularly illustrates an example of variation of signal SELECT and of signals A1 and A2 respectively representative of the selection of antennas 210A and 210B (FIG. 2). It is, for example, assumed that a high state of signal A1, A2 corresponds to a case where antenna 210A, 210B is selected, while a low state of signal A1, A2 corresponds to a case where antenna 210A, 210B is not selected.

According to this embodiment, it is arbitrarily considered that: antenna 210A is selected (signal A1 in the high state) and antenna 210B is not selected (signal A2 in the low state) when binary signal SELECT is in a low state; and antenna 210B is selected (signal A2 in the high state) and antenna 210A is not selected (signal A1 in the low state) when binary signal SELECT is in a high state.

In relation with FIG. 3, an example of variation over time t of signals SELECT, A1, and A2 at successive times t0, t1, and t2 is considered hereafter.

At time t0, signal SELECT is in the low state. Antenna 210A is thus selected while antenna 210B is not selected. This, for example, enables a NFC device with circuit 200 (FIG. 2) to communicate in near field with another NFC device to exchange data.

At time t1, signal SELECT is switched from the low state to the high state. This causes a deselection of antenna 210A and a selection of antenna 201B. Such a switching of signal SELECT to the high state occurs, for example, in a situation where it is desired to use the NFC device with circuit 200 to charge a battery of another NFC device located within its range.

At time t2, signal SELECT is switched from the high state to the low state. This causes a deselection of antenna 210B and a selection of antenna 201A. Such a switching of signal SELECT to the low state, for example, corresponds to a situation where the battery of the other NFC device located within range has been sufficiently charged. The NFC device with circuit 200 may then exchange data again via antenna 210A.

According to the embodiment discussed in relation with FIG. 3, the near-field communication antennas 210A and 210B of the NFC device are thus alternately selected and/or activated according to the state of signal SELECT.

FIG. 4 very schematically shows in the form of blocks an example of a cell phone 400, for example, a smartphone, comprising a near-field communication circuit of the type of the circuit 200 described in relation with FIG. 2. Thus, in the example of FIG. 4, telephone 400 comprises elements similar to those of the circuit 200 of FIG. 2 (in FIG. 4, these elements are shown in dotted lines). Such elements may however, in the example of integration illustrated in FIG. 4, be coupled by links shown differently than in FIG. 2.

In the case of the cell phone 400 such as illustrated in FIG. 4: antenna 210A is preferably an antenna optimized for data exchanges between cell phone 400 and other NFC devices (not shown), for example, a so-called frame antenna located in the upper portion of phone 400; and antenna 210B is an antenna dedicated to the charging of other NFC devices.

Antennas 210A and 210B, as well as the antennas within NFC devices capable of being charged via the antenna 210B of phone 400, are configured to operate at a frequency in the order of 13.56 MHz, preferably equal to 13.56 MHz.

According to an embodiment, antenna 210B enables to deliver, to the NFC devices to be charged, an electric supply power in the range from approximately 250 mW to approximately 1 W. The electric supply power delivered by the antenna 210B of phone 400 is preferably equal to approximately 250 mW, 500 mW, 750 mW, or 1 W, more preferably equal to 250 mW, 500 mW, 750 mW, or 1 W (values such as defined in the wireless charging specifications of the NFC Forum (Wireless Charging (WLC) Candidate Technical Specification)).

Generally, the antenna 210B of phone 400 can be distinguished from antennas designed to perform energy transfers by induction according to the Qi standard. In particular, conversely to antenna 210B, the antennas compatible with the Qi standard: use frequencies typically in the range from 80 kHz to 300 kHz (to be compared with 13.56 MHz for antenna 210B); and are capable of delivering electric powers typically ranging up to 5 W, for so-called low power applications, and up to 120 W, for so-called medium-power applications (to be compared with 1 W maximum for antenna 210B).

It could thus be believed that NFC antenna 210B is not adapted to charges and that a Qi antenna should be used. However, in the described embodiments, advantage is conversely taken from what appears as a disadvantage to charge low power devices. Thus, the antenna 210B of telephone 400 is particularly adapted to the charge of NFC devices provided with batteries of low capacity, typically smaller than 200 mAh, and capable of being charged due to an electric power smaller than 1 W.

In the embodiment illustrated in FIG. 4, a central processor 402 (HOST) of telephone 400 is coupled, preferably connected, to NFC controller 202. In this case, processor 402 imposes to NFC controller 202 the high or low state of signal SELECT (FIG. 2), thus enabling to select and/or to activate one or the other of antennas 210A and 210B, as discussed in relation with FIG. 3. For example, processor 402 acts on the state of signal CMD to control the state of signal SELECT at the output of NFC controller 202.

According to an embodiment, the state of signal SELECT depends on the state of at least one sensor of cell phone 400. In particular, the activation of the antenna 210B dedicated to the near-field charging is preferably conditioned by the state of one or of a plurality of sensors selected among: an accelerometer 404, preferably a three-axes accelerometer; a gyroscope 406; a luminosity sensor 408, for example, an ambient luminosity sensor; and a proximity sensor 410.

According to another embodiment, the activation of antenna 210B, and thus state of signal SELECT, may occur: when phone 400 is connected to an external power source, for example, when it is detected that a plug (not shown) is inserted into a charging socket 412 of phone 400, which advantageously enables to avoid discharging a battery (not shown) of phone 400 for another battery of a NFC device to be charged; and/or during standby or off periods of a screen 414 of phone 400.

According to still another implementation mode, the activation of antenna 210B may be conditioned by a capacitive detection of the presence of a NFC device close to phone 400. In this case, phone 400 behaves as a first electrode of a planar capacitor, the second electrode of this capacitor being formed by the NFC device to be charged. By evaluating a capacity variation between a situation where no NFC device to be charged is brought close to phone 400 and another situation where a NFC device to be charged is placed with the range of, for example, in contact with, phone 400, the present of the NFC device to be charged can thus be detected.

The previously-described embodiments may be combined, that is, the previously-described conditions of activation of antenna 210B may be combined with the state conditions of the sensor(s) of phone 400.

According to a preferred embodiment, the antenna 210B of phone 400 is activated when phone 400 is laid, on the side of its display 414, on a substantially fixed support. In this case, antenna 210B is, for example, activated: if accelerometer 404 detects no motion of phone 400; if gyroscope 406, ambient luminosity sensor 408, and proximity sensor detect that the front surface of the phone, that is, the surface comprising screen 414, is in contact with an underlying support; and if a plug in inserted into the charging socket 412 of phone 400.

According to an implementation mode, the activation of antenna 210B is enabled by an actuator capable of receiving an operator's action (operator action), for example, a sensor 416 located on the back side of phone 400. In this case, the enabling of the activation of antenna 210B is preferably performed by single tap or by double tap on the sensor 416 of phone 400. Tap means a short pressure of the user's finger, such pressures being close in time in case of a double tap.

According to another embodiment, the activation of antenna 210B is enabled by an operator action, preferably a double tap, on any area of phone 400. In this case, the detection of the operator action is for example performed due to accelerometer 404.

The detection of an operator action such as those described hereabove may, however, be omitted, in other words, the selection of the antenna 210A or 201B to be activated is then performed with no action from an operator.

As a variation, the antennas 210A and 210B of phone 400 are periodically activated. In this case, signal SELECT is, for example, a periodic signal generated by processor 402 from a synchronization signal or clock signal.

According to an embodiment, the conditions enabling to activate one or the other of the antennas 210A and 210B, of phone 400 are parameterized at the factory, for example, by a manufacturer of phone 400, and/or subsequently parameterized by a user of phone 400, for example, from a software menu or an application executed by phone 400. Further, the manufacturer and/or the user of phone 400 may parameterize the use of any combination of the above-listed conditions to control the selective activation of the antennas 210A and 210B of phone 400. Such a selection is for example performed according to the conditions which may enable to discern, with the greatest possible certainty, the different cases of use of phone 400 to activate the adequate antenna 210A, 210B.

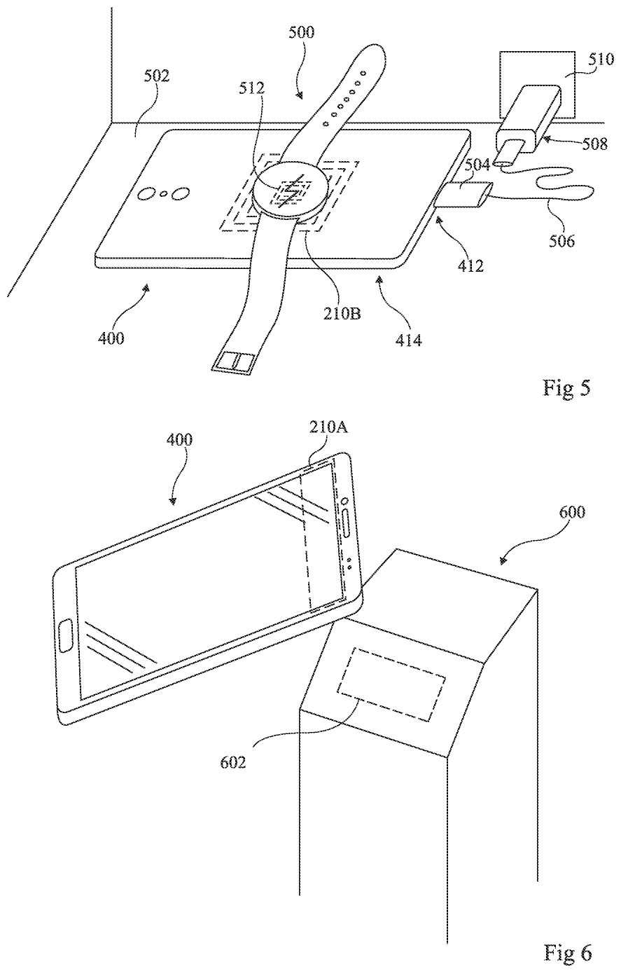

FIG. 5 illustrates an example of application to the charging, by a cell phone, of a connected object. More particularly, FIG. 5 illustrates an example of application to the charging, by the phone 400 of FIG. 4, of a smartwatch 500.

In the example of FIG. 5, phone 400 is laid upside down, that is, on the side of its display 414, on a support 502, for example, the ground. A plug 504, inserted into charge socket 412 of phone 400, is connected by a cable 506 to a charging accessory 508 or charger. Charger 508 is connected to an external power source 510, for example, a wall socket coupled to an electric power distribution network.

Smartwatch 500 is arranged on the back of phone 400, in other words on the back side of phone 400, that is, on the side opposite to its display 414. The energy transfer between antenna 210B of phone 400 and smartwatch 500 is thus optimized.

According to an embodiment, phone 400 and watch 500 are equipped with a magnetic system (not shown) for aligning watch 500 with respect to antenna 210B of phone 400. An example of such an alignment system comprises providing a magnet (not shown) at the center of antenna 210B of phone 400 and another magnet (not shown) at the center of a near-field communication antenna 512 of watch 500. Thereby, when watch 500 is laid on the back of phone 400, the magnetic alignment system enables to align the antenna 512 of watch 500 with respect to the antenna 210B of phone 400. The energy transfer between antennas 210B and 512 is thus further optimized by near-field coupling, which thus optimizes the electric charging power delivered by phone 400 to watch 500.

The described embodiments and implementation modes advantageously enable a user to charge watch 500 without needing to have a charging accessory dedicated to watch 500. In other words, the implementation of the method of charging watch 500 with phone 400 dispenses from using charging accessories specific to watch 500.

Although this is not shown, what has been described hereabove in relation with an example of application where a smartwatch 500 is charged by a cell phone 400 more generally applies to any charging of a connected object by a mobile terminal. Adapting the described embodiments and implementation modes to other mobile terminals, particularly tablet computers, and to other connected objects, particularly smartbands or fitness monitors, is within the abilities of those skilled in the art based on the above indications.

FIG. 6 illustrates an example of application to a data exchange between a mobile terminal and another device. More precisely, FIG. 6 illustrates an example of application to a data exchange between the phone 400 of FIG. 4 and an electronic terminal 600.

In the example of FIG. 6, electronic terminal 600 comprises a near-field communication antenna 602. Telephone 400 is, for example, positioned close to electronic terminal 600 to bring antenna 210A of phone 400 closer to antenna 602 of terminal 600. In the configuration shown in FIG. 6, antenna 210B (FIG. 4) is deactivated while antenna 210A is activated.

The phone 400 thus positioned is capable of exchanging data with terminal 600 (or more generally any NFC device). In particular, the antenna 210A of phone 400 is capable of: emitting an electromagnetic field sensed by antenna 602 of terminal 600, phone 400 then for example being configured in reader mode while terminal 600 is configured in card mode; or sensing an electromagnetic field emitted by antenna 602 of terminal 600, phone 400 then for example being configured in card mode while terminal 600 is configured in reader mode.

Generally, as previously described in relation with FIGS. 5 and 6, cell phone 400 is configured to alternately activate one or the other of its antennas 210A, 210B according to the cases of use of phone 400.

Although this is not shown, what has been described hereabove in relation with an example of application where cell phone 400 communicates in near field with a terminal 600 more generally applies to any near-field communication between two NFC devices. Adapting the described embodiments and implementation modes to other mobile terminals, particularly tablet computers, and to other connected objects, particularly smartbands or physical activity monitors, is within the abilities of those skilled in the art based on the above indications.

Various embodiments, implementation modes, and variations have been described. Those skilled in the art will understand that certain features of these various embodiments, implementation modes, and variants, may be combined and other variants will occur to those skilled in the art. In particular, although embodiments and implementation modes where phone 400 comprises two near-field communication antennas, one of these antennas being dedicated to the charge of another NFC device, have been described, it will be within the abilities of those skilled in the art to adapt what is described hereabove to cases where phone 400 comprises more than two near-field communication antennas, at least one of these antennas being dedicated to the charging of another NFC device.

Finally, the practical implementation of the described embodiments, implementation modes, and variants is within the abilities of those skilled in the art based on the functional indications given hereabove. In particular, the physical implantation of the elements forming the circuit 200 of FIG. 2 in NFC devices is within the abilities of those skilled in the art.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A method for operating a first electronic device that includes a near-field communications circuit, a first near-field communication antenna and a second near-field communication antenna, comprising:
controlling a switching circuit to alternately couple the first and second near-field communication antennas of said first electronic device to a radio-frequency (RF) port of the near-field communications circuit;
wherein the second antenna is configured for and dedicated to the charging of a second electronic device.

2. The method according to claim 1, wherein the first near-field communication antenna is configured for and dedicated to supporting data exchanges between the first and second electronic devices.

3. The method according to claim 1, wherein the second electronic device comprises a third near-field communication antenna.

4. The method according to claim 3, wherein the first, second, and third near-field communication antennas are configured to operate at a frequency in the order of 13.56 MHz.

5. The method according to claim 1, wherein the switching circuit is controlled by the near-field communications circuit to couple to the second near-field communication antenna in response to detection of a state of one or more of a plurality of sensors of the first electronic device.

6. The method according to claim 5, wherein the plurality of sensors comprise:
an accelerometer, preferably a three-axes accelerometer;
a gyroscope;
a luminosity sensor; and
a proximity sensor.

7. The method according to claim 1, wherein the switching circuit is controlled by the near-field communications circuit to couple to the second near-field communication antenna in response to detection of the first electronic device being connected to an external power source.

8. The method according to claim 1, wherein the switching circuit is controlled by the near-field communications circuit to couple to the second near-field communication antenna in response to an enabling by an operator action of an actuator.

9. The method according to claim 1, wherein the switching circuit is controlled by the near-field communications circuit to couple to the second near-field communication antenna during standby or off periods of a display of the first electronic device.

10. The method according to claim 1, wherein the switching circuit is controlled by the near-field communications circuit to couple to the second near-field communication antenna in response to an output of a capacitive sensor of the first electronic device.

11. The method according to claim 1, wherein the first and second electronic devices are equipped with a magnetic system for aligning the second electronic device with respect to the second near-field communication antenna.

12. The method according to claim 1, wherein controlling the switching circuit comprises periodically switching between coupling to the first near-field communication antenna and coupling to the second near-field communication antenna.

13. The method according to claim 1, wherein the first electronic device is a mobile terminal.

14. The method according to claim 13, wherein the mobile terminal is selected from the group consisting of a cell phone and a tablet computer.

15. The method according to claim 1, wherein the second electronic device is a connected object.

16. The method according to claim 15, wherein the connected object is selected from the group consisting of a smartwatch and a smartband.

17. A device comprising said first and second near-field communication antennas, wherein the device is configured to implement the method of claim 1.

18. A cell phone comprising said first and second near-field communication antennas, wherein said cell phone is configured to implement the method of claim 1.
